(19) United States
(12) Patent Application Publication
(10) Pub. No.: US 2004/0107263 A1
(43) Pub. Date: Jun. 3, 2004

(54) Communication system with function of encryption/decryption by agency

(75) Inventors: Hidehiko Fujiwara, Kanagawa (JP); Yoshikazu Kobayashi, Kanagawa (JP)

Correspondence Address: FOLEY AND LARDNER, SUITE 500, 3000 K STREET NW, WASHINGTON, DC, 20007, US

(73) Assignee: NEC Infrontia Corporation

(21) Appl. No.: 10/720,129

(22) Filed: Nov. 25, 2003

(30) Foreign Application Priority Data
Nov. 29, 2002 (JP) 2002-348068

(51) Int. Cl. G06F 15/16

(52) U.S. Cl. 709/210; 709/202

(57) ABSTRACT

An agency communication section is equipped in an intranet, and when communications are made with a slave unit on the Internet which is located outside a firewall, the agency communication section executes encryption/decryption by agency in place of a slave unit having no mechanism for encryption in the intranet. The slave unit having a mechanism for encryption judges whether it is located inside or outside the firewall, and executes encryption if it is located outside or executes no encryption if it is located inside.

### BACKGROUND OF THE INVENTION

1. Field of the Invention

The present invention relates to a communication system for executing communications by using the Internet, and particularly to a technique when a private branch IP telephone system is constructed in an intranet.

2. Description of the Related Art

It has been generally popular on an intra-company information network or the like to construct a strong firewall between an intranet and the Internet. When a private branch IP telephone system is constructed in an intranet protected by such a firewall, it is preferable to execute voice communications by making most of normal RTP connection without using encryption in order to secure mutual connectivity for communications or reduce the communication band.

JP-A-2001-237888 (patent document 1) and JP-A-11-284726 (patent document 2) have disclosed some communication systems. The patent document 1 describes that voice data are subjected to secret processing (on paragraphs 0161 to 0164 of the specification). The patent document 2 describes a system in which when a calling person wishes to talk with a transmitter of an electronic mail or the like on the telephone, voice connection is automatically established by utilizing information on a communication party (i.e., the transmitter concerned) on the computer of the calling person (on paragraphs 0017 to 0020 of the specification).

In the case where the private branch IP telephone system is constructed in an intranet as described above, if voice communications or data communications are executed through the RTP connection without using encryption, voice data or numeric data from a slave unit moved outside the firewall may be stolen by a third party on the Internet because no encryption is executed on the communications with the slave unit. Therefore, if simple encryption is executed, it would be required to add an encryption processing function to all the slave units in the intranet. As a result, the mutual connectivity would be lowered, and the communication band would be increased. If it is impossible to adapt the slave unit side to encryption because it is impossible to remodel slave units, there would occur a problem that it is impossible to execute communications.

The patent documents 1 and 2 disclose the systems for executing communications of voice data or the like, however, neither the system disclosed in the patent document 1 nor the system disclosed in the patent document 2 can solve the above problem.

### SUMMARY OF THE INVENTION

The present invention has been implemented in view of the foregoing problem, and has an object to provide a communication system that can surely protect communications even when a slave unit in an intranet has no encryption mechanism.

In order to attain the above object, according to the present invention, a system for executing communications between a slave unit in an intranet protected by a firewall and another slave unit located outside the firewall through the Internet, is characterized by including an agency communication section that is equipped to the intranet and executes encryption or decryption by agency for a slave unit having no mechanism for encryption in the intranet.

### BRIEF DESCRIPTION OF THE DRAWINGS

FIG. 1 is a block diagram showing an embodiment of the present invention; and

FIG. 2 is a flowchart showing the operation of the embodiment.

### DETAILED DESCRIPTION OF THE PREFERRED EMBODIMENT

A preferred embodiment according to the present invention will be described hereunder with reference to the accompanying drawings.

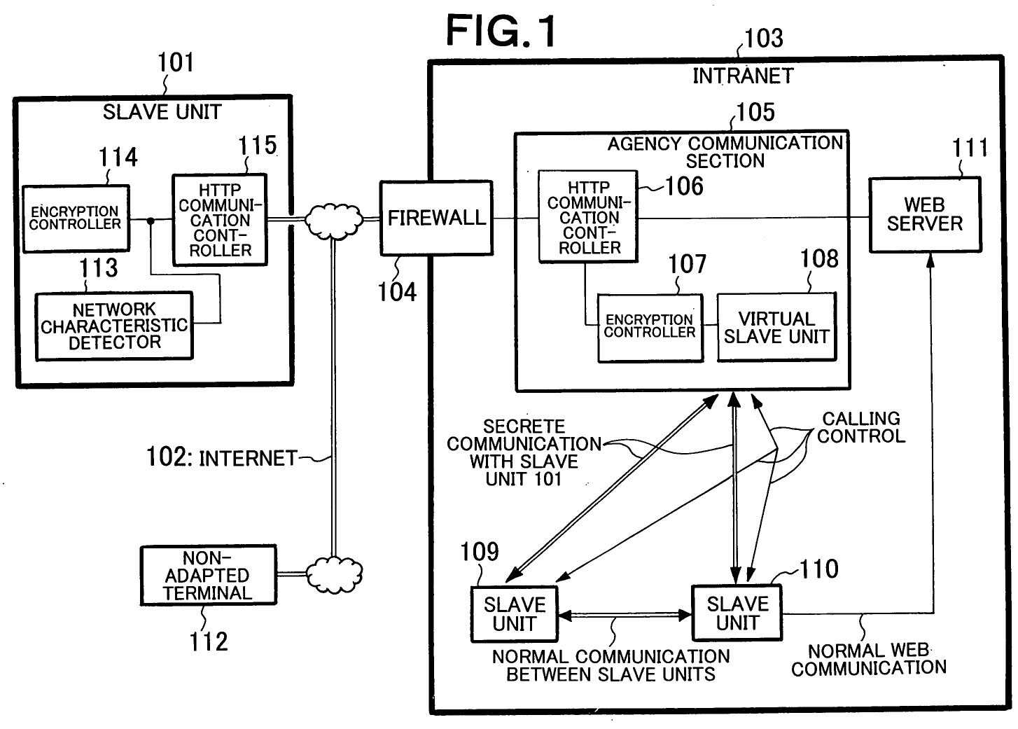

FIG. 1 is a block diagram showing an embodiment of the present invention. In FIG. 1, reference numeral 101 represents a slave unit, reference numeral 102 represents the Internet, reference numeral 103 represents an intranet, and reference numeral 104 represents a firewall for protecting the intranet 103. The intranet 103 is equipped with an agency communication section 105 that resides on the intranet 103 at all times and executes encryption/decryption as an agent. The slave unit 101 is a slave unit on the Internet 102, and it is assumed to have a mechanism for encryption.

Reference numerals 109, 110 represent slave units in the intranet 103, and reference numeral 111 represents a Web server in the intranet 103. The slave units 109, 110 are assumed to have no mechanism for encryption. Reference numeral 112 represents an encryption non-adapted terminal which is not adapted to encryption on the Internet 102.

The agency communication section 105 includes an HTTP communication controller 106, an encryption controller 107 and a virtual slave unit 108. The encryption controller 107 in the agency communication section 105 encrypts communications to the slave unit 101 on the Internet 102 which is not protected by the firewall 104, thereby protecting the content of the communications. That is, the encryption controller 107 executes encryption in place of the slave units 109 and 110 having no mechanism for encryption. Furthermore, the encryption controller 107 of the agency communication section decrypts, by agency, communications from the slave unit 101 which is located outside the firewall 104 and has a mechanism for encryption. Therefore, the communications can be performed between the slave unit 101 outside the firewall 104 and each of the slave units 109 and 110 inside the firewall 104.

In this case, at a negotiation time when the communications are started, the agency communication section 105 judges on the basis of the information of mutual communication parties whether they are terminals adapted to encryption or not, what kind of encryption is used, etc. Accordingly, on the basis of this judgment result, the agency communication section 105 decrypts the communications when an access is made from the slave unit 101 outside the firewall 104 to the slave unit 109 or 110 inside the firewall 104. Conversely, the agency communication section 105 encrypts the communications when an access is made from the slave unit 109 or 110 to the slave unit 101.

Furthermore, when an access is made from the slave unit 109 or 110 inside the firewall 104 to the slave unit 101 outside the firewall 104, the slave machine 101 encrypts the communications because it is a terminal adapted to encryption. When an access is made from the slave unit 109 or 110 to the encryption non-adapted terminal 112, the communications are made without being encrypted. At this time, the communications may be inhibited.

In this embodiment, the agency communication section 105 executes encryption/decryption by agency as described above, so that the slave units 109 and 110 inside the firewall 104 are not required to execute encryption/decryption. Therefore, slave units having no mechanism for encryption can coexist in the system. Accordingly, a private branch IP telephone system having high connectivity can be constructed.

Furthermore, the virtual slave unit 108 is equipped to the agency communication section 105. The virtual slave unit 108 has the same function as the slave units 109 and 110 inside the firewall 104, and also has the function of converting voice and data formats to go beyond the firewall 104 (for example, conversion function to HTTP packet format). Accordingly, in the case where the communications are made between the slave unit 101 and the slave unit 109 or 110, the slave units 109 and 110 see the virtual slave unit 108 although they actually communicate with the slave unit 101 when viewed from the slave units 109 and 110. On the other hand, the slave unit 101 sees the virtual slave unit 108 when viewed from the slave unit 101. That is, the virtual slave unit 108 executes the communications as an agent in place of these slave units.

The virtual slave unit 108 executes the communications by agency as described above, so that all the slave units such as the slave units 109, 110, etc. located in the intranet 103 protected by the firewall 104 can communicate in a non-encrypted standard data format such as RTP without needing any special mechanism. This data communication is represented as a secret communication with the slave unit 101 in FIG. 1. Therefore, the connectivity to general private branch IP telephones is guaranteed.

Furthermore, even when the slave units 109 and 110 in the intranet 103 cannot be equipped with a mechanism for encryption, they can execute secret communications with the slave unit 101 outside the firewall 104 through the virtual slave unit 108 and the encryption controller 107. In addition, the encryption controller 107 in the agency communication section has a function of analyzing encrypted data, and judges whether the data corresponds to a Web access or encrypted private branch IP telephone communication.

The HTTP communication controller 106 controls to make the communications to the Web server 111 if the judgment result indicates the Web access, or to make communications to the slave unit 109 or 110 serving as a communication party if the judgment result indicates the encrypted private branch IP telephone communication. As described above, according to this embodiment, it is judged whether the data corresponds to the Web access or the private branch IP telephone communication, and the access through HTTP of the firewall 104 (one port of the firewall 104) can be managed on the basis of the above judgment, so that the safety of the firewall 104 can be confirmed.

The slave unit 101 outside the firewall 104 includes a network characteristic detector 113, an encryption controller 114 and an HTTP communication controller 115. The network characteristic detector 113 judges the connection environment of the network by using a method of judging whether normal RTP communications can be executed or not, or the like, and judges whether the slave unit 101 is located inside or outside the firewall 104 at present.

On the basis of the above judgment, the operation of the encryption controller 114 is switched. Specifically, it is controlled so that encryption is executed if the slave unit 101 is judged to be located outside the firewall 104 or encryption is not executed if the slave unit 101 is judged to be located inside the firewall 104. By switching encryption/non-encryption in accordance with the position of the slave unit 101 with respect to the firewall 194 (inside or outside the firewall 104), the connectivity of the slave unit 101 to other devices can be enhanced irrespective of the position of the slave unit 101 (inside or outside the firewall 104). Particularly, when the slave unit 101 is located outside the firewall 104, the communications can be automatically switched to secret communications without user's paying attention to it.

Furthermore, even when a slave unit has no mechanism for encryption like the encryption non-adapted terminal 112, there is no problem because the encryption controller 107 has the function of analyzing the content in the RTP packet. That is, when it is confirmed that an access is made from an encryption non-adapted terminal 112 at the negotiation time when the communications are started, the virtual slave unit 108 executes communications without encryption by agency, and thus the connectivity can be also secured in a terminal which is not adapted to encryption.

For example, if the network manager sets up the agency communication section 105 in the intranet 103 such as his/her home or company in advance, the network manager can execute secret communications irrespective of the position of the slave unit 101 (inside or outside the firewall 104) by merely carrying the slave unit 101. Furthermore, devices existing inside the firewall 104 can make secret communications with the slave unit 101 outside the firewall 104 without individually preparing any mechanism for encryption.

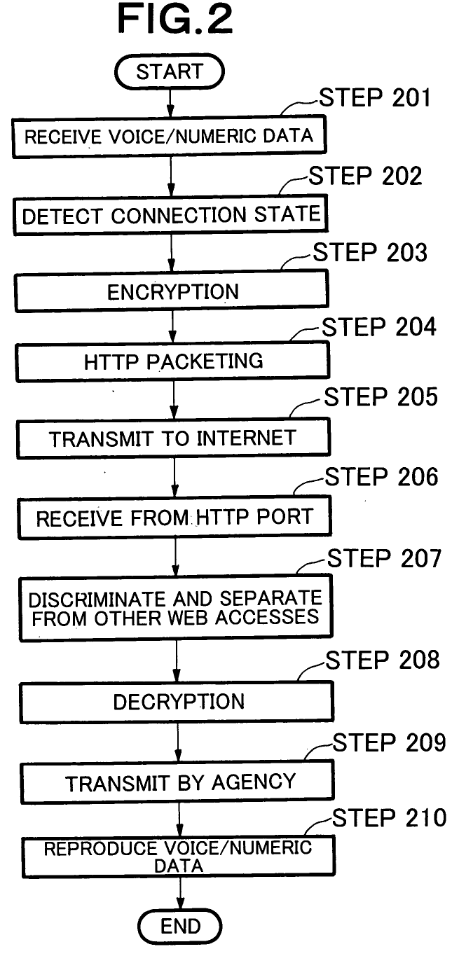

Next, the operation of this embodiment will be described with reference to the flowchart of FIG. 2. In the following description, the operation for the secret communications from the outside of the firewall 104 will be described.

In FIG. 2, voice/numerical data are first received in the slave unit 101 (step 201). The connection environment of the network is judged on the basis of the judgment made by the network characteristic detector 113 as to whether the normal RTP communications can be executed or not. It is judged whether the slave unit 101 is inside the firewall 104 or outside the firewall 104 (step 202). At this time, it is assumed that the slave machine 101 is judged to be outside the firewall 104.

Subsequently, the encryption controller 114 in the slave unit 101 executes encryption (step 203), and the HTTP communication controller 115 subjects the packet concerned to HTTP packet conversion (step 204) and then transmits it to the Internet 102 (step 205). This HTTP packet is passed through the HTTP port of the firewall 104 and received by the HTTP communication controller 106 of the agency communication section 105 (step 206). As described above, at the negotiation time, the encryption controller 107 judges whether the HTTP packet is encrypted voice/numeric data or not, and on the basis of the judgment result, the HTTP communication controller 106 discriminate, separate it from other Web accesses (step 207).

At this time, the data is the encrypted HTTP packet, and thus the HTTP communication controller 106 of the agency communication section 105 subjects the encrypted HTTP packet to non-HTTP-packeting, and further the encryption controller 107 executes decryption on the non-HTTP-packeted data (step 208). The virtual slave unit 108 transmits the decrypted voice/numeric data by agency (step 209), and the data thus transmitted is reproduced by the slave unit 109 or 110 (step 210).

When the slave unit 109 or 110 inside the firewall 104 communicates with the slave unit 101 outside the firewall 104, it is judged at the negotiation time that the slave unit 101 serving as a communication party is a slave unit adapted to encryption, so that the virtual slave unit 108 of the agency communication section 105 executes communications by agency and the encryption controller 107 encrypts the voice/numeric data.

Furthermore, the HTTP communication controller 106 executes HTTP-packeting on the data, and then an HTTP packet thus achieved is transmitted through the HTTP port of the firewall 104 onto the Internet 102 and received by the slave unit 101. The HTTP communication controller 115 of the slave unit 101 subjects the HTTP packet thus received to non-HTTP-packeting, and the encryption controller 114 decrypts the data thus non-HTTP-packeted.

still furthermore, when the slave unit 109 or 110 inside the firewall 104 communicate with the non-adapted terminal 112 outside the firewall 104, the agency communication section 105 judges at the negotiation time that the communication party is not adapted to encryption. At this time, the communications are executed without being encrypted. Alternatively, the communications may be inhibited.

As described above, the present invention has the following effects.

(1) The agency communication section executes encryption/decryption by agency. Therefore, all the slave units in the intranet are not required to be adapted to encryption, and a slave unit having no mechanism for encryption can directly make secret communications with an encrypted slave unit outside an firewall.

(2) As compared with an encrypting tool such as VPN or the like with which connectivity cannot be guaranteed in some mid course on the Internet which is beyond the management, the method of communications passing through the HTTP port of the firewall can implement high connectivity.

(3) The normal Web access and the private branch IP telephone communication can be can be discriminated from each other by analyzing the content of the packet, so that the packets passing through the HTTP port of the firewall can be managed and the safety can be enhanced.

(4) The network characteristic detector judges whether the position of the slave unit is inside or outside the firewall, and the encryption/non-encryption is switched on the basis of the judgment result. Therefore, the slave machine can make secret communications if the slave unit is located outside the firewall, and the connectivity can be secured if the slave unit is located inside the firewall.

(5) Connection from an encryption non-adapted terminal outside the firewall can be also guaranteed.

What is claimed is:

1. A system for executing communications between a slave unit in an intranet protected by a firewall and another slave unit located outside the firewall through the Internet, the system comprises:
an agency communication section equipped to the intranet for executing encryption or decryption by agency for a slave unit having no mechanism for encryption in the intranet.

2. The communication system according to claim 1, wherein
said agency communication section executes the communications without encryption, when an access is made from a slave unit which is located outside the firewall and is not adapted to encryption.

3. The communication system according to claim 1, wherein
said agency communication section executes communications without encryption or inhibits communications, when an access is made from a slave unit inside the firewall to a terminal which is located outside the firewall and is not adapted to encryption.

4. The communication system according to claim 2, wherein
said agency communication section executes communications without encryption or inhibits communications, when an access is made from a slave unit inside the firewall to a terminal which is located outside the firewall and is not adapted to encryption.

5. The communication system according to claim 1, wherein
said agency communication section has a virtual slave unit having the function of the slave unit and a function of converting voice and data formats to go beyond the firewall, and said virtual slave unit executes communications by agency.

6. The communication system according to claim 2, wherein
said agency communication section has a virtual slave unit having the function of the slave unit and a function of converting voice and data formats to go beyond the firewall, and said virtual slave unit executes communications by agency.

7. The communication system according to claim 3, wherein
said agency communication section has a virtual slave unit having the function of the slave unit and a function of converting voice and data formats to go beyond the firewall, and said virtual slave unit executes communications by agency.

8. The communication system according to claim 1, wherein
said agency communication section analyzes the encrypted data to judge whether the encrypted data indicates a Web access or encrypted private branch IP telephone communication, and executes the communications to a Web server or a slave unit in the intranet on the basis of the judgment result.

9. The communication system according to claim 2, wherein
said agency communication section analyzes the encrypted data to judge whether the encrypted data indicates a Web access or encrypted private branch IP telephone communication, and executes the communications to a Web server or a slave unit in the intranet on the basis of the judgment result.

10. The communication system according to claim 3, wherein
said agency communication section analyzes the encrypted data to judge whether the encrypted data indicates a Web access or encrypted private branch IP telephone communication, and executes the communications to a Web server or a slave unit in the intranet on the basis of the judgment result.

11. The communication system according to claim 1, wherein
the communications between a slave unit inside the intranet and a slave unit on the Internet are executed through an HTTP port of the firewall.

12. The communication system according to claim 2, wherein
the communications between a slave unit inside the intranet and a slave unit on the Internet are executed through an HTTP port of the firewall.

13. The communication system according to claim 3, wherein
the communications between a slave unit inside the intranet and a slave unit on the Internet are executed through an HTTP port of the firewall.

14. The communication system according to claim 1, wherein
a slave unit having a mechanism for encryption is used, and said slave unit has means for judging whether said slave unit is located inside or outside the firewall, said slave unit executing encryption if it is judged by said means that said slave unit is located outside the firewall or stopping the encryption function if it is judged by said means that said slave unit is located inside the firewall.

15. The communication system according to claim 2, wherein
a slave unit having a mechanism for encryption is used, and said slave unit has means for judging whether said slave unit is located inside or outside the firewall, said slave unit executing encryption if it is judged by said means that said slave unit is located outside the firewall or stopping the encryption function if it is judged by said means that said slave unit is located inside the firewall.

16. The communication system according to claim 3, wherein
a slave unit having a mechanism for encryption is used, and said slave unit has means for judging whether said slave unit is located inside or outside the firewall, said slave unit executing encryption if it is judged by said means that said slave unit is located outside the firewall or stopping the encryption function if it is judged by said means that said slave unit is located inside the firewall.
